(19) United States
(12) Patent Application Publication
(10) Pub. No.: US 2024/0142139 A1
(43) Pub. Date: May 2, 2024

(54) SOLAR PANEL SYSTEM WITH SOLAR TRACKING AND DUAL LOCKING-HINGES

(71) Applicant: Nicholas D. Wilson, Portland, OR (US)

(72) Inventor: Nicholas D. Wilson, Portland, OR (US)

(21) Appl. No.: 18/051,976

(22) Filed: Nov. 2, 2022

(51) Int. Cl. F24S 50/20; F24S 50/60; G05B 19/4155; H02S 20/32

(52) U.S. Cl. CPC F24S 50/20; F24S 50/60; G05B 19/4155; H02S 20/32; G05B 2219/37283

(57) ABSTRACT

A solar panel system includes solar tracking and dual locking hinges. A solar panel assembly may be connected to a base via a linear actuator, actuator arm, and lever arm, which in connection of either of the two locking hinges acting as an axis of rotation, form a toggle joint mechanism for tilting the solar panel assembly to a desired angle in a desired direction. The desired angle may be automatically determined using solar tracking algorithms using data from light sensors, or may be controlled manually by a user. The locking hinges may include electromagnetic locks, which may lock the associated hinge to the base when energized, and unlock the associated hinge when de-energized. To tilt the solar panel assembly in one of two directions, one hinge is locked and the other unlocked, allowing the unlocked end to move upward to achieve the desired tilt angle.

### TECHNICAL FIELD

The technical field of the disclosed embodiments relate to solar panel systems with solar tracking. More particularly, the disclosed embodiments relate to a solar panel system with solar tracking and dual locking hinges, each hinge in turn being capable of acting as an axis of rotation for tilting the solar panel(s).

### BACKGROUND

Solar panels may be used to collect solar energy for conversion into electrical energy. One technique for increasing the amount of available solar energy is to increase the number of solar panels in an array, which also increases the footprint of the array. This may not be feasible in certain circumstances, for example, a solar array mounted on a vehicle, or the roof of a house or building, with limited surface area.

Solar tracking systems may tilt a solar panel array in a direction that attempts to maximize the amount of light received by the solar panels. However, single-axis systems may have a limited maximum tilt angle. Dual-axis systems may better track the sun, but are more complex and prone to glitches and mechanical failures. Both types of systems may be unstable in high wind situations, such as a hurricane, as the solar panel array is typically mounted on an axis joint rather than a stable surface such as the ground or a roof.

### SUMMARY

A solar panel system according to an embodiment includes solar tracking and dual locking hinges. A solar panel assembly including a frame and solar panels may be connected to a base or mount via a linear actuator, actuator arm, and lever arm, which in connection of either of the two locking hinges acting as an axis of rotation, form a toggle joint mechanism for tilting the solar panel assembly to a desired angle in a desired direction. The desired angle may be automatically determined using solar tracking algorithms using data from light sensors, or may be controlled manually by a user.

The locking hinges may include electromagnetic locks, which may lock the associated hinge to the base when energized, and unlock the associated hinge when de-energized.

To tilt the solar panel assembly in one of two directions, one hinge is locked and the other unlocked, allowing the unlocked end to move upward to achieve the desired tilt angle. The direction of the angle of tilt depends on which locking hinge is locked, and which is disengaged.

The solar panel assembly may be returned to a flat, default position in response to a default event, such as light falling below a threshold, wind speed exceeding a threshold, or the ignition system of a vehicle the system is mounted on being activated.

The solar panel frame may be connected to the lever arm by a rotatable clamp. The clamp may slide along a rail as the lever arm is raised in response to the linear actuator moving the actuator arm, similar to a gantry structure, and clamp the lever arm and solar panel assembly at a desired location corresponding to a desired angle. As the actuator arm is retracted, the lever arm is raised, and the solar panel frame increases its angle of tilt. The clamp may rotate to accommodate this change in tilt angle.

A user may manually control the system using a user interface (UI) on a user device. The user may control the system to move in either direction, and to return to the flat, default position.

### BRIEF DESCRIPTION OF THE DRAWINGS

FIG. 1 shows a solar panel system according to an embodiment.

FIG. 2 shows a solar panel assembly for use in the solar panel system of FIG. 1 according to an embodiment.

FIG. 3 is a top view of the solar panel assembly according to an embodiment.

FIG. 4 shows a position of the solar panel frame assembly in which the right locking hinge is locked and left locking hinge is disengaged for tilting the solar panel assembly in a rightwards direction.

FIG. 5 shows a position of the solar panel frame assembly in which the left locking hinge is locked and right locking hinge is disengaged for tilting the solar panel assembly in a leftwards direction.

FIG. 6 shows components of a controller according to an embodiment.

FIG. 7 shows a network to which the solar panel system may connect for communication with other devices and systems according to an embodiment.

FIG. 8 is a flowchart describing an automatic controller operation according to an embodiment.

FIG. 9 shows a user interface (UI) which may be used on a user's mobile device to manually control the solar panel system according to an embodiment.

FIG. 10 is a flowchart describing a manual operation of the solar panel system according to an embodiment.

### DETAILED DESCRIPTION

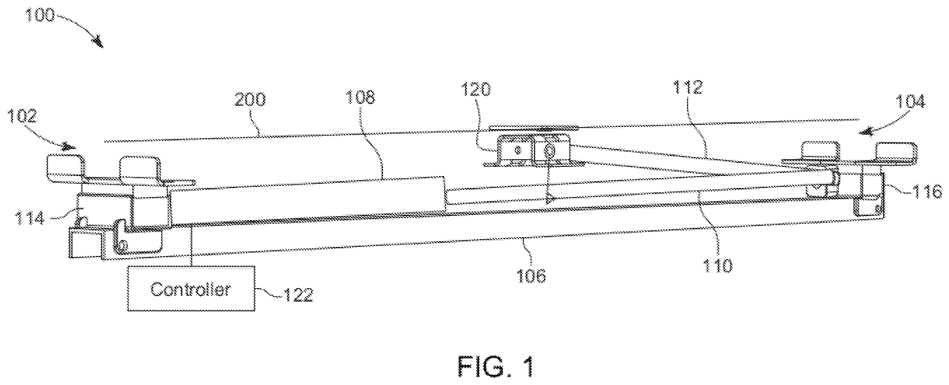

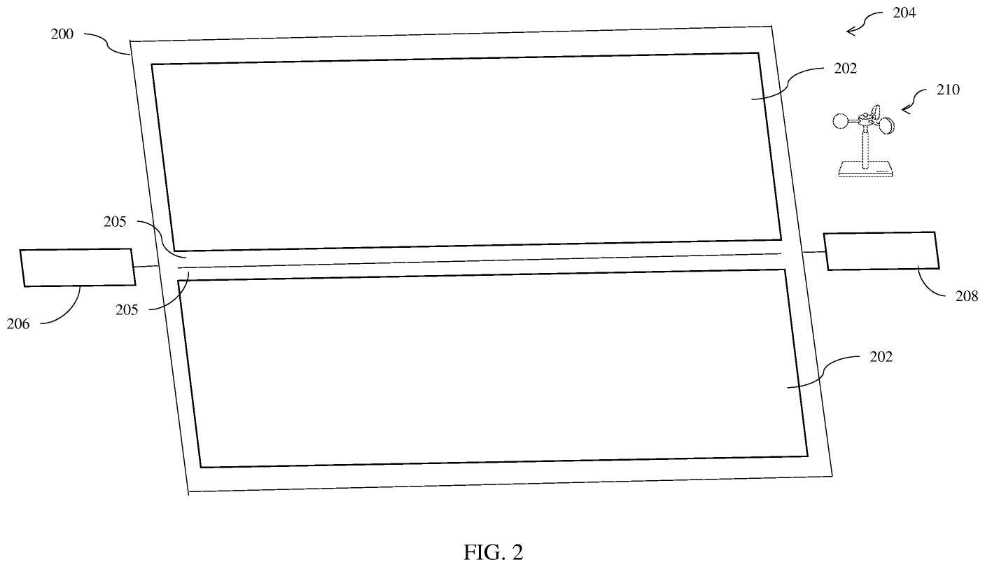

FIG. 1 shows solar panel system 100 with solar tracking and dual locking hinges 102, 104. A solar panel frame 200, shown in FIG. 2, may be connected to a base 106 via a linear actuator 108, actuator arm 110, and lever arm 112, which in connection of either of the two locking hinges 102, 104 acting as an axis of rotation, form a toggle joint mechanism for tilting the solar panel frame 200 and attached solar panels 202, together referred to as a solar panel assembly 204, to a desired angle.

In an embodiment, the locking hinges 102, 104, described herein as left and right hinges, respectively, may include electromagnetic locks. Left and right hinge solenoids 114, 116, respectively, may lock the associated hinge to the base when energized, and unlock the associated hinge when de-energized. In another embodiment, the locking hinges 102, 104 may be mechanical locks, for example, a servomotor clamping mechanism.

FIG. 1 shows the solar panel system 100 in a flat, locked position in which both the left and right hinges are locked. This may be a default position when there is little or no solar energy being received by the solar panels, for example, at night. The system may also return to the locked position when wind speed reaches, or is predicted to reach, a threshold wind speed, as described in more detail below.

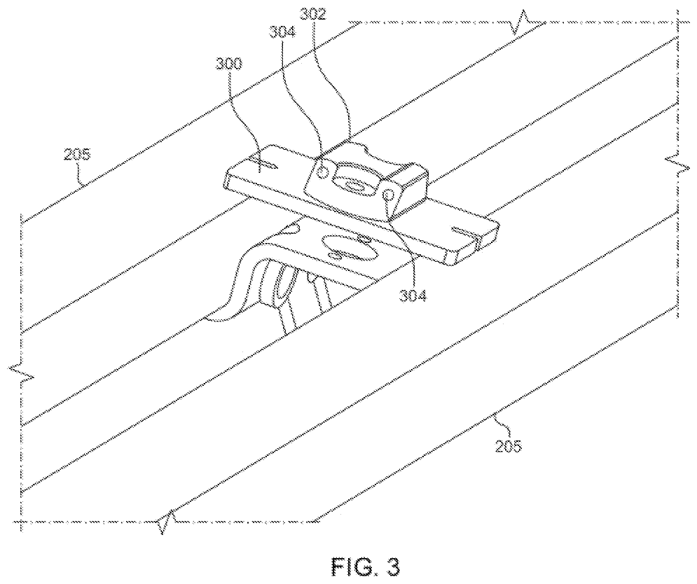

The solar panel frame 200 may be connected to the lever arm 112 by a rotatable clamp 120. The clamp 120 may be positioned under the solar panel assembly 204 and be connected a mating part 300 positioned on the top of the solar panel frame, as shown in FIG. 3. The mating part 300 and connected clamp 120 slide between two parallel rails 205 separating the solar panels 202.

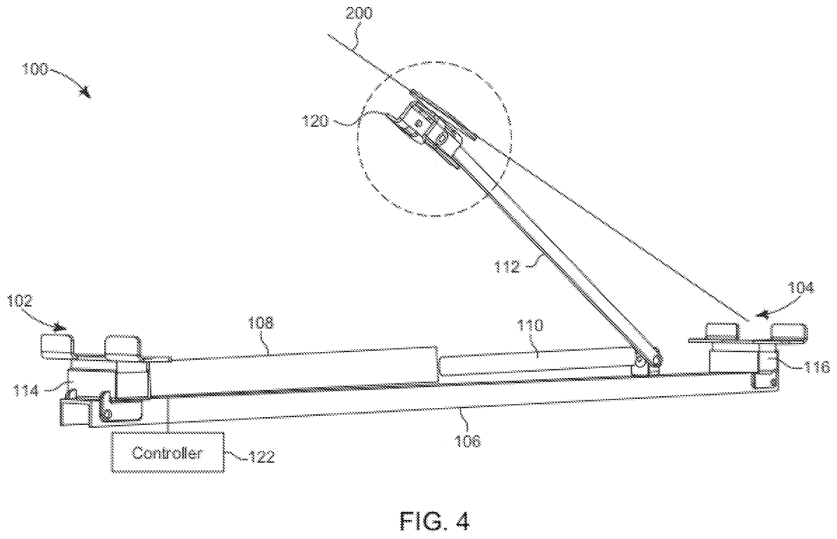

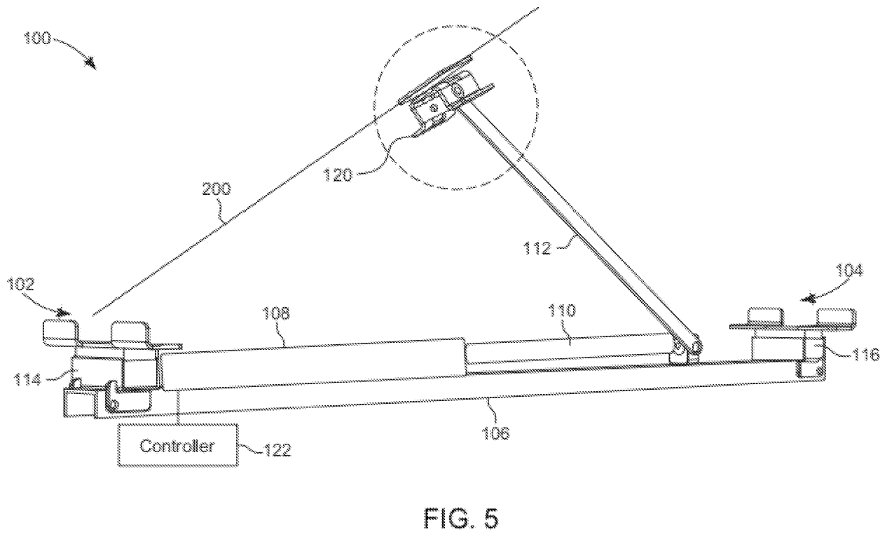

The clamp 120 and connected mating part 300 may be slide along the rails 205 as the lever arm 112 is raised in response to the linear actuator 108 moving the actuator arm 10, similar to a gantry structure. The clamp 120 may clamp and secure the lever arm 112 and solar panel assembly 204 at a desired location corresponding to a desired angle. As the actuator arm 110 is retracted, the lever arm 112 is raised, and the solar panel assembly 204 increases its angle of tilt. The clamp 120 may rotate to accommodate this change in tilt angle. The direction of the angle of tilt depends on which locking hinge is locked, and which is disengaged, as shown in FIGS. 4 and 5.

FIG. 4 shows a position of the solar panel frame assembly 204 in which the right locking hinge 102 is locked and left locking hinge 104 is disengaged. As the linear actuator 108 retracts the actuator arm 110, the lever arm 112 is raised, and the angle of the solar panel assembly increases in relation to the axis, in this case, right locking hinge 102. As the linear actuator 108 extends the actuator arm 110, the lever arm 112 is raised, and the angle of the solar panel assembly decreases.

FIG. 5 shows a position of the solar panel frame assembly 204 in which the left locking hinge 104 is locked and the right locking hinge is disengaged. The actuator arm 110 and lever arm 112 are in the same position, but the solar panel assembly 204 is angled in the other direction.

The linear actuator 108 may by controlled by a controller 122. In an embodiment, left and right light sensors 206, 208, respectively, may be mounted on the solar panel assembly 204, as shown in FIG. 2. A variety of light sensor types may be compatible with the system, for example, light sensitive diodes (photocells), photoresistors, light dependent resistors (LDRs), etc. Solar tracking modules including multiple sensors in a single unit may also be employed.

In an embodiment including left and right light sensors 206, 208, if the controller determines the left light sensor 206 is receiving more light energy, indicative of there being more sun and solar energy in that direction, the controller 122 may disengage the right locking hinge 104 while the left locking hinge 102 remains engaged, as in FIG. 5. The controller 122 may control the linear actuator 108 to retract the actuator arm 112, thereby pushing the center pivot point of the solar panel assembly 204 upwards, causing the panel array to angle towards the sun. Once the sensor inputs equalize, the controller 122 may control the linear actuator 108 to stop. Once the linear actuator 108 has reached its lowest limit, the panel should be flat. As the sun continues to move towards the right light sensor 208, the controller 122 may swap locking hinge engagements, as shown in FIG. 4, and begin to lift the center pivot point again, repeating the process in the opposite direction.

In an embodiment, the light sensors 206, 208 may be connected to the controller 122 using signal wires and use a communication protocol such as the I-squared-C (I2C) protocol.

In another embodiment, two or more light sensors may be mounted on a controller, for example, four light sensors, with two for each direction. The mating part 300 may include a module 302 that houses four fiber optic lens caps 304 (left facing lens caps shown). Each of these lens caps may be connected to a fiber optic light pipe which leads down to a corresponding light sensor on the controller 112. The controller 112 may record the amount of light (lux) being taken in by that lens cap in the module. By comparing these 4 inputs, the microcontroller can determine where the light source is the strongest, and adjust from there.

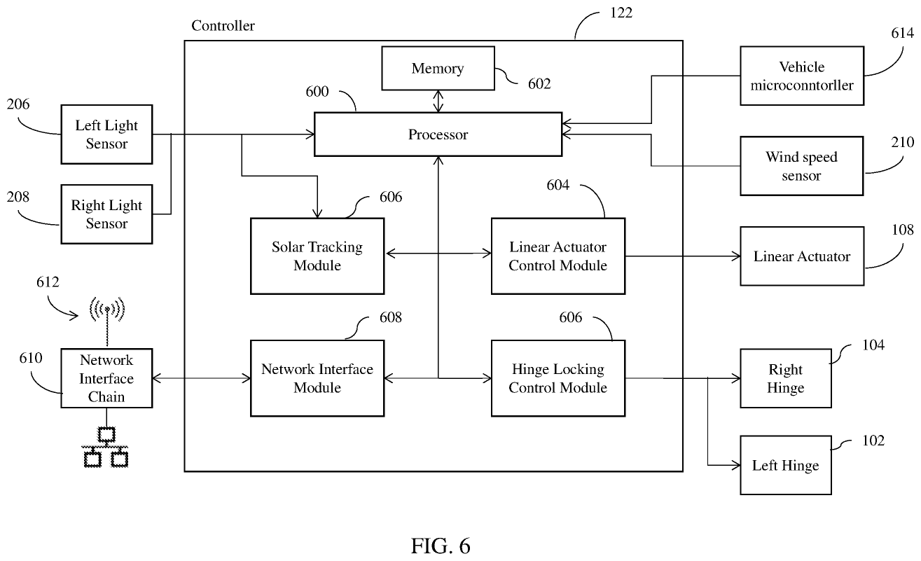

FIG. 6 shows components of the controller 112 according to an embodiment. The controller may include a processor 600 including a memory device 602. The processor 600 may receive data from the various sensors and operate on them and/or send them to other modules in the controller 112 for processing. The memory device 602 may store instructions for the processor and other modules to perform various operations, and store and buffer sensor data.

A solar tracking module 604 may use the data from the light sensors 206, 208 to determine a preferred position of the solar panels to receive solar energy based on the sun's position. The solar tracking module 604 may employ one or more of various solar tracking algorithms, including, for example, open-loop, closed-loop, combined open- and closed-loop schemes, fuzzy logic, proportional-integral-derivative (PID), etc. The solar tracking module 604 may utilize and select from different solar tracking algorithms depending on conditions such as cloud cover or change of geographic location of the solar panel system 100, for example, for a vehicle mounted system.

It may be desirable to lock the solar panel assembly 204 in the flat, default position in certain circumstances even when there is available light. In an embodiment, the solar panel system 100 may be mounted on a vehicle. When the vehicle is moving, it may be desirable to have the solar panel assembly 204 locked in the flat, default position for a variety of reasons including, for example, maintaining an aerodynamic profile of the vehicle when traveling at high speeds, protecting the structural integrity of the solar panel system 100 from high air speeds generated by the velocity of the vehicle and/or ambient air speed (wind), and to lower the profile of the vehicle when traveling under a structure, such as an underpass. The solar panel system may also be mounted on static structures, such as the roof of a house or other building, on the ground, or on a tower. It may be desirable to have the solar panel assembly 204 locked in the flat, default position in high wind situations, such as a hurricane or other storm system in order to protect the structural integrity of the solar panel system from the force generated by high wind speeds.

A hinge locking control module 606 may receive data directly or via the processor 600 from the light sensors 206, 208 and a wind speed sensor 210, such as a wind cup anemometer, duct wind sensors, ultrasonic wind sensors, etc. The hinge locking control module may use this data to determine when to engage or disengage either hinge, or to control the system to return to the flat, default position with both hinges locked.

According to an embodiment, the hinge locking control module 606 may cause the system to returned to the locked, flat, default position in response to the potential solar energy available falling below a light threshold, the wind speed sensor 210 detecting, or the processor 600 predicting, wind speeds that are or are predicted to exceed a wind speed threshold, the vehicle ignition being engaged in the case of a vehicle mounted system, or a manually entered command received from a user device, as described below with respect to a user interface (UI) on a user device.

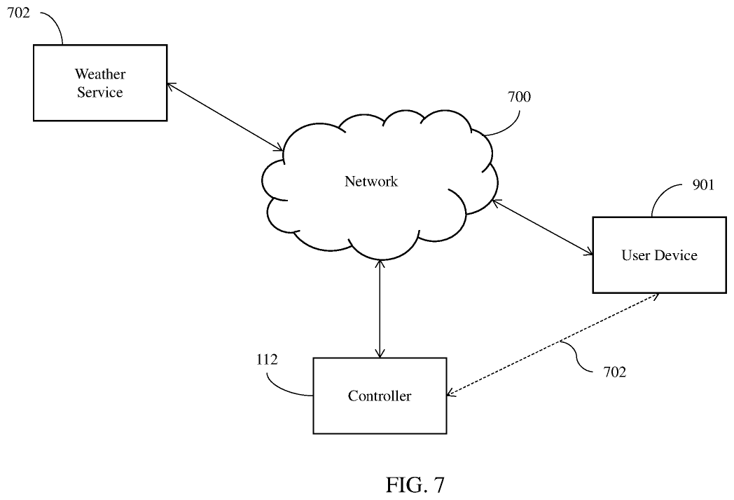

The controller 112 may also receive data from an external weather service 702 via a network 700, as shown in FIG. 7. An exemplary service is the National Oceanic and Atmospheric Administration (NOAA), which provides weather forecast models and solar position data and predictions. The processor 600 may use this additional information in conjunction with the real-time sensor data received from the on-board light and wind speed sensors to compare with the real-time sensor data for accuracy and/or predict solar position and climate conditions to be used, for example, in case of sensor failure.

The network 700 may include wired and wireless communication connections, and combinations thereof. A wired communication connection(s) may include Ethernet (IEEE 802.3) or other LAN technologies. The wireless network communication connection(s) may include, for example, Bluetooth (IEEE 802.15.1), 4G (LTE-A, WiMAX 2.0) (IEEE 802.16m), IOT, WiFi (IEEE 802.11), ultra-wideband (UWB) (IEEE 802.15.3), Zigbee (IEEE 802.15.4), etc. The wired and/or wireless communication connections may employ encrypted protocols and unique identification numbers.

The controller 122 may communicate with the network, wireless local networks, or direct connections, e.g., Bluetooth and WiFi, via a network interface module 608 and a network interface chain 610 including networking hardware and software including, for example, a network interface card (NIC), a transceiver, wired and/or wireless modem, and antenna 612.

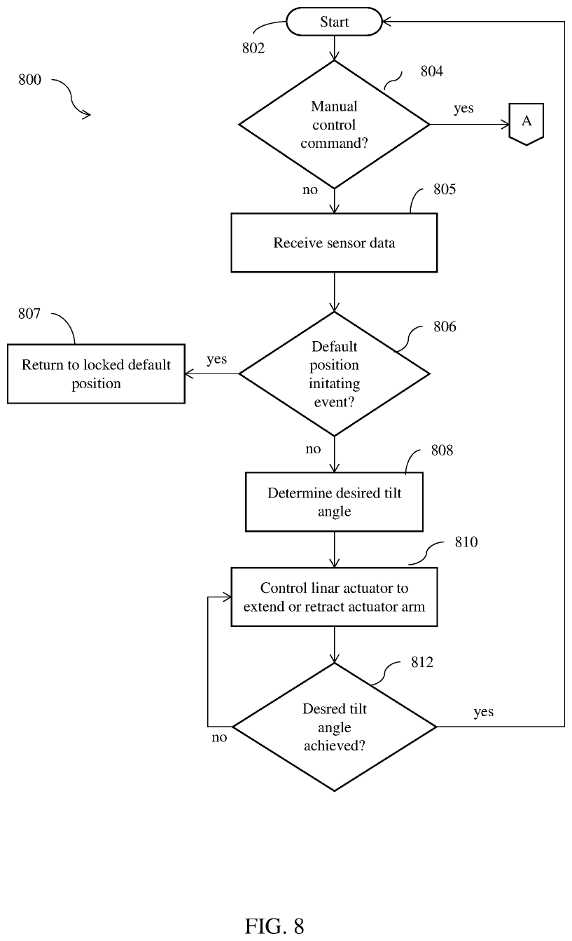

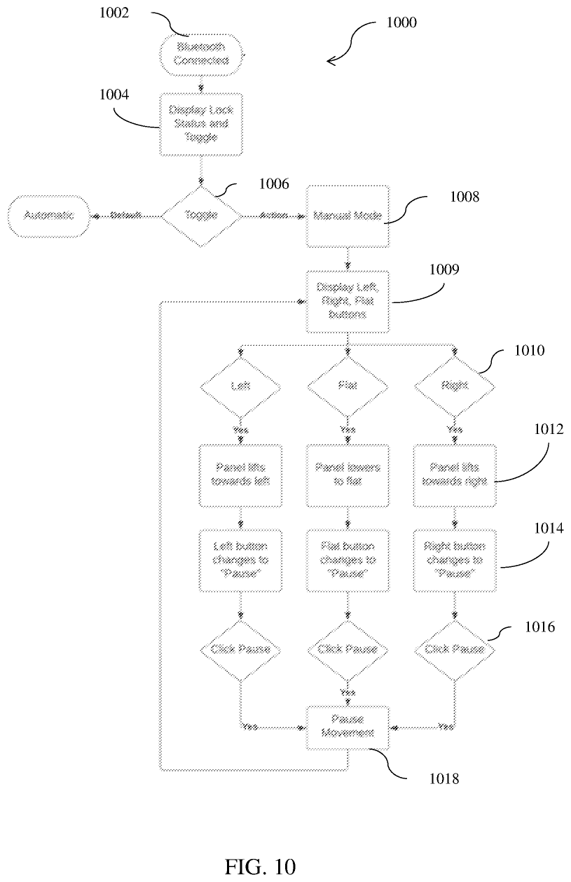

FIG. 8 describes a controller operation 800 according to an embodiment. The operation may start 802 in response to a manual (user) or automatic command. If the controller receives a command for manual operation 804 from the user device, the operation continues (A) to the manual operation 1000 shown in FIG. 10.

The processor receives sensor data 805 from the light sensors 206, 208 and data from a vehicle microcontroller 614 (if mounted on a vehicle) and the wind speed sensor 210. If a default initiating event is detected 806, for example, received light falls below a light threshold, wind speed exceeds a wind speed threshold, or the vehicle microcontroller indicates that the vehicle ignition has been activated, the processor may send a command to the linear actuator control module to return the solar panel assembly to the default, flat position 807 and commands the hinge locking control module to lock both hinges.

Otherwise, the solar tracking module determines a desired tilt angle 808 for the solar panel and the controller 122 commands the linear actuation control module control the linear actuator 108 to move the actuator arm 810 to a position corresponding to the desired tilt angle. The processor may confirm the solar panel assembly is at the desired position based on real-time data from the light sensors 206, 208 and/or data from the weather service. Once the desired tilt angle is achieved 812, the operation 800 may return to start 802.

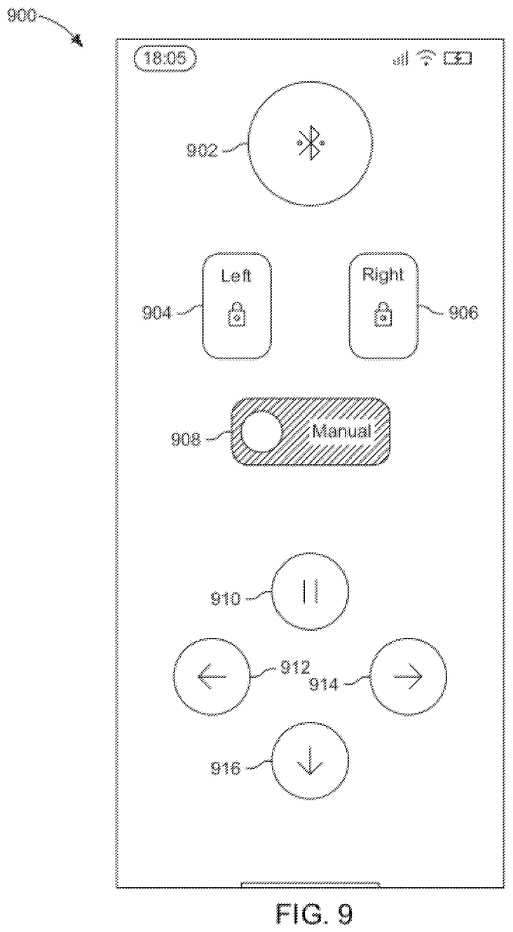

The system 100 may also be controlled manually by a user via a user interface (UI) 900 on a user device. FIG. 9 shows a UI 900 which may be used on a mobile device 901 according to an embodiment. Although variations are contemplated, in an embodiment the UI 900 may include a network connection status/control (virtual) status icon 902, left and right hinge lock icons 904, 906, respectively, manual control selection (toggle) button 908, a pause button 910, left track button 912, right track button 914, and a “flat” button 916.

FIG. 10 shows a manual operation 1000 of the system 100 according to an embodiment. In an embodiment, the user device 901 may connect directly to the system 100 via a Bluetooth connection 702, as shown in FIG. 7. The user device determines if a Bluetooth connection is activated 1002. If so, the UI 900 displays the lock icons 904, 906 and toggle 908 as active 1004, for example, going from shaded (inactive) to highlighted (active). In an embodiment, the lock icons may merely show the status of the respective hinge locks, and do not provide control. The toggle 908 may be set to “automatic” as a default. If the user controls the toggle to “manual” 1006, the operation enters a manual mode 1008. Upon entering the manual mode, the left track button, right track button, pause button, and flat button may be displayed as active 1009, for example, going from shaded (inactive) to highlighted (active).

If the left track button 912 is selected 1010, the left hinge is locked and the right hinge disengaged. The linear actuator moves the actuator arm, and hence the lever arm, to move the solar panel assembly to the left 1012. The left track button 912 icon may change to a pause icon 1014 after it is selected. Once the button is selected again 1016, the movement is paused 1018. Similarly, if the right track button 914 is selected, the right hinge is locked and the left hinge is disengaged and the solar panel assembly moves to the right. If the flat button 916 is selected, the linear actuator is controlled to lower the solar panel assembly to the flat, default position.

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A solar panel system, comprising:
a mount;
a solar panel assembly including a frame and a plurality of solar panels, the solar panel assembly including a top side, a bottom side, a first end, and a second end;
a rail connected to the solar panel assembly;
a rotatable clamp slidably mounted on the rail;
a first hinge positioned on a same side as the first end of the solar panel assembly;
a first locking mechanism operative to engage with the first hinge;
a second hinge positioned on a same side as the second end of the solar panel assembly;
a second locking mechanism operative to engage with the second hinge;
an actuator arm having a first end and a second end;
a linear actuator connected to the mount and the first end of the actuator arm and operative to extend and retract the actuator arm;
a lever arm connected at a first end to the second end of the actuator arm and connected at a second end to the clamp; and
a controller operative to
control the linear actuator in order to change a tilt angle of the solar panel assembly, and
engage one of the hinge locking mechanism and disengage the other locking mechanism to enable movement of the solar panel assembly into a range of tilted positions, and
engage both hinge locking mechanisms in a flat position of the solar panel assembly.

2. The solar panel system of claim 1, wherein the controller is further operative to move the solar panel assembly to the flat position in response to a default event.

3. The solar panel system of claim 2, further comprising a plurality of light sensors,
wherein the controller is further operative to
determine a desired tilt angle of the solar panel assembly in response to data received from the light sensors, and
control the linear actuator to move the actuator arm into a position corresponding to the desired tilt angle, and
wherein the default event comprises receiving data from the light sensors indicating light received falls below a light threshold.

4. The solar panel system of claim 2, further comprising a wind sensor,
wherein the default event comprises receiving data from the wind sensor indicating a wind speed exceeding a wind speed threshold.

5. The solar panel system of claim 2, wherein the controller is further operative to receive data from a vehicle microprocessor, and
wherein the default event comprising receiving data from the vehicle microprocessor indicating a vehicle ignition system has been activated.

6. The solar panel system of claim 1, wherein the first and second hinge locking mechanisms comprise magnetic locking systems.

7. The solar panel system of claim 1, wherein the controller is further operative to enter a manual mode in response to receiving a user command.

8. A non-transitory computer-readable medium including instructions operative to cause a computer to:
engage one of first and second hinge locking mechanisms in a solar panel system and disengage the other locking mechanism to enable movement of a solar panel assembly into a range of tilted positions, and
control a linear actuator to move an actuator arm connected to a lever arm connected to a frame of the solar panel assembly in order to change a tilt angle of the solar panel assembly; and
engage both hinge locking mechanisms in a flat position of the solar panel assembly.

9. The non-transitory computer-readable medium of claim 8, further comprising instructions operative to
move the solar panel assembly to the flat position in response to a default event.

10. The non-transitory computer-readable medium of claim 8, further comprising instructions operative to
determine a desired tilt angle of the solar panel assembly in response to data received from a plurality of light sensors, and
control the linear actuator to move the actuator arm into a position corresponding to the desired tilt angle, and
move the solar panel assembly to the flat position in response to receiving an indication from the light sensors indicating light received by the light sensors falls below a light threshold.

11. The non-transitory computer-readable medium of claim 8, further comprising instructions operative to
move the solar panel assembly to the flat position in response to receiving data from a wind sensor indicating a wind speed exceeding a wind speed threshold.

12. The non-transitory computer-readable medium of claim 8, further comprising instructions operative to
move the solar panel assembly to the flat position in response to receiving data from a vehicle microprocessor indicating a vehicle ignition system has been activated.

13. The non-transitory computer-readable medium of claim 8, further comprising instructions operative to enter a manual mode in response to receiving a user command.
